(19) United States
(12) Patent Application Publication
(10) Pub. No.: US 2026/0083182 A1
(43) Pub. Date: Mar. 26, 2026

(54) ATOMIZATION CORE, METHOD OF MANUFACTURING ATOMIZATION CORE, AND ATOMATION DEVICE

(71) Applicant: Shanghai QV Technologies Co., Ltd., Shanghai (CN)

(72) Inventors: Liheng Tang, Shanghai (CN); Zhijun Jiang, Shanghai (CN); Huamei Li, Shanghai (CN); Xiaofeng Peng, Shanghai (CN)

(21) Appl. No.: 19/109,647

(22) PCT Filed: Sep. 8, 2023
(86) PCT No.: PCT/CN2023/117759

§ 371 Date: Mar. 7, 2025

(30) Foreign Application Priority Data
Sep. 9, 2022 (CN) 202211104863.4

(51) Int. Cl. A24F 40/70; A24F 40/10; A24F 40/46; A24F 40/485; H05B 3/46

(52) U.S. Cl. CPC A24F 40/70; A24F 40/10; A24F 40/46; A24F 40/485; H05B 3/46

(57) ABSTRACT

The disclosure provides a method of manufacturing an atomization core, an atomization core and an atomization device. The manufacturing method includes: providing a raw substrate, including a first surface and a second surface opposite to the first surface, and a plurality of substrate units, each of the substrate units defining an array of holes running through the first surface and the second surface; forming a resistive layer intermediate products first surface, and the resistive layer including a plurality of conductive parts corresponding to the substrate units, respectively. In this way, firstly, the resistive layer is formed on the entire first surface of the raw substrate, and then the conductive part of the resistive layer is processed so that the conductive part can form a first region that overlaps with the array of holes.

### CROSS REFERENCE TO RELATED DISCLOSURE

Priority is claimed to Chinese Patent Application No. CN202211104863.4, filed on Sep. 9, 2022, the entire disclosure of which is hereby incorporated by reference herein.

### TECHNICAL FIELD

The present disclosure relates to atomization devices and, in particular, to an atomization core, a method of manufacturing the atomization core, and an atomization device.

### BACKGROUND

Currently, electronic atomization devices are being widely used. Oil is heated by an atomization core of the electronic atomization device and is thereby atomized into aerosol. In related art, the atomization core includes a core substrate and an electrical resistive layer formed on the core substrate as an electrothermal film. In mass production, a pattern of the electrical resistive layer is formed on a raw substrate using a mask. However, employment of the mask increases complexity and precision requirements of the raw substrate, thus increasing processing cost of the atomization core.

### SUMMARY

The present disclosure embodiment provides a method of manufacturing an atomization core, an atomization core, and an atomization device.

Firstly, the method of manufacturing an atomization core includes:
providing a raw substrate, in which the raw substrate includes a first surface and a second surface opposite to the first surface, the raw substrate defines a plurality of substrate units, and each of the substrate units defines an array of holes running through the first surface and the second surface;
forming a resistive layer on the entire first surface, and the resistive layer including a plurality of conductive parts corresponding to the substrate units, respectively;
processing each of the conductive parts to form a first region and a second region electrically insulated from the first region, the first region overlapping with the corresponding array of holes.

In the manufacturing method of the some embodiments of this disclosure, firstly, the resistive layer is formed on the entire first surface of the raw substrate, and then the conductive part of the resistive layer is processed so that the conductive part can form a first region that overlaps with the array of holes. Comparing with forming a single substrate unit first and then setting the conductive layer on the single substrate unit, the manufacturing method is more efficient and can save the cost of manufacturing the atomization core.

In some embodiments, the step of processing of the conductive parts on the substrate units to form a first region and a second region insulated from the first region includes:
planning a processing path on the conductive parts;
removing materials from the conductive parts in accordance with the processing path to form a first insulating slot, the first insulating slot separating each of the conductive parts into a first region and a second region, and the first insulating slot passing across each of the arrays of holes.

In some embodiments, the step of removing materials from the conductive parts in accordance with the processing path to form a first insulating slot includes:
removing the materials from the conductive parts in accordance with the processing path to form a first slot and a second slot. The first slot and the second slot are apart from each other, and both pass across the array of holes, the first region being formed between the first slot and the second slot, and the first insulating slot including the first slot and the second slot.

In some embodiments, the method further includes:
arranging electrodes on the first region.

In some embodiments, the first region includes a heating zone and an electrical connection zone connected to the heating zone, the electrical connection zone locates outside the corresponding array of holes, and the heating zone overlaps with the array of holes;

The step of arranging electrodes on the first region includes:
arranging the electrodes on the electrical connection zone.

In some embodiments, the method further includes:
removing materials from the second region to form a second insulating slot, the second insulating slot separating the second region into two insulating sub-regions as a first sub-region and a second sub-region, the second sub-region corresponding to a top end of the first region;

In some embodiments, the step of arranging electrodes on the first region includes:
coating a conductive material to the first sub-region and the first region; and solidifying the conductive material to form the electrodes.

In some embodiments, the method further includes:
separating the raw substrate with the resistive layer by the location of the substrate unit to form a plurality of chips, each of the chips includes one substrate unit and one conductive part.

In some embodiments, the step of forming a resistive layer on the entire first surface includes:
forming a resistive layer on the entire first surface.

Secondly, the atomization core includes:
a core substrate, the core substrate defining an array of holes therethrough in a thickness direction thereof;
a conductive part, the conductive part being in slice and lying on the core substrate, the conductive part comprising a first region and a second region insulated from the first region, the first region overlapping with the array of holes.

In some embodiments, the conductive part defines a first insulating slot, and the first insulating slot separates the conductive part into a first region and a second region, while passing through the array of holes.

In some embodiments, the first insulating slot defines a first slot and a second slot, and the first slot and the second slot being spaced apart from each other while both passing through the array of holes, the first region locates between the first slot and the second slot.

In some embodiments, the atomization core includes electrodes formed on the first region, and the electrodes is electrically connected to the first region.

In some embodiments, the first region includes a heating zone and an electrical connection zone connected to the heating zone, the electrical connection zone locates outside the array of holes, the heating zone overlapping with the array of holes, and the electrodes is arranged on the electrical connection zone.

In some embodiments, the second region defines a second insulating slot, the second insulating slot separates the second region into a first sub-region and a second sub-region electrically insulated from the first sub-region, the first sub-region corresponds to the electrical connection region, and the electrodes extend from the electrical connection region to the first sub-region, covering at least part of the first sub-region.

Thirdly, an atomization core is provided, and the atomization core is made by the method as being described in any of the above embodiments.

Fourthly, the atomization device in the present disclosure includes the atomization core as being described in any of the above embodiments.

Additional aspects and advantages of the present disclosure will be given in the following parts of description, and become apparent, or be known from the practice of the present disclosure.

### BRIEF DESCRIPTION OF THE DRAWINGS

The foregoing and/or additional aspects and advantages of the present disclosure will become apparent and easily understood from the description of the embodiments through the accompanying drawings below, wherein:

FIG. 1 is a schematic figure of a method of manufacturing an atomization core according to an embodiment of the present disclosure;

FIG. 2 is a flow chart of the method according to the embodiment of the present disclosure;

FIG. 3 is a section figure of the atomization core according to the embodiment of the present disclosure;

FIG. 4 is another flow chart of the method according to the embodiment of the present disclosure;

FIG. 5 is another schematic figure of the method according to the embodiment of the present disclosure;

FIG. 6 is a schematic figure of an intermediate product of the atomization core during method according to the embodiment of the present disclosure;

FIG. 7 is another schematic figure of the method according to the embodiment of the present disclosure;

FIG. 8 is another flow chart of the method according to the embodiment of the present disclosure;

FIG. 9 is another schematic figure of the method according to the embodiment of the present disclosure;

FIG. 10 is another flow chart of the method according to the embodiment of the present disclosure;

FIG. 11 is further another schematic figure of the method according to the embodiment of the present disclosure;

FIG. 12 is further another flow chart of the method according to the embodiment of the present disclosure;

FIG. 13 is a schematic figure of the atomization core according to the embodiment of the present disclosure; and

FIG. 14 is a perspective figure of the atomization device according to the embodiment of the present disclosure.

### DESCRIPTION OF LABELS FOR ELEMENTS

atomization core 100, raw substrate 10, first surface 12, second surface 14, substrate unit 16, array of holes 18, resistive layer 20, conductive part 22, first region 24, second region 26, first insulating slot 28, first slot 30, second slot 32, electrode 34, heating zone 36, electrical connection zone 38, second insulation slot 40, first sub-region 42, second sub-region 44, chip 46, core substrate 48, atomization device 200.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

In the present disclosure, unless specified or limited otherwise, the first characteristic is “on” or “under” the second characteristic refers to the first characteristic and the second characteristic can be direct or via media indirect mountings, connections, and couplings. And, the first characteristic is “on”, “above”, “over” the second characteristic may refer to the first characteristic is right over the second characteristic or is diagonal above the second characteristic, or just refer to the horizontal height of the first characteristic is higher than the horizontal height of the second characteristic. The first characteristic is “below” or “under” the second characteristic may refer to the first characteristic is right over the second characteristic or is diagonal under the second characteristic, or just refer to the horizontal height of the first characteristic is lower than the horizontal height of the second characteristic.

The following disclosure provides a plurality of different embodiments or examples to implement the different structures of this application. In order to simplify the disclosure of this application, specific examples of components and settings will be described below. Of course, they are only examples and are not intended to limit this application. In addition, this application may repeat reference numbers and/or reference letters in different examples for the purpose of simplification and clarity, and does not itself indicate the relationship between the various embodiments and/or settings discussed. In addition, the present disclosure provides examples of various specific processes and materials, but ordinary technical personnel in this field can be aware of the application of other processes and/or the use of other materials.

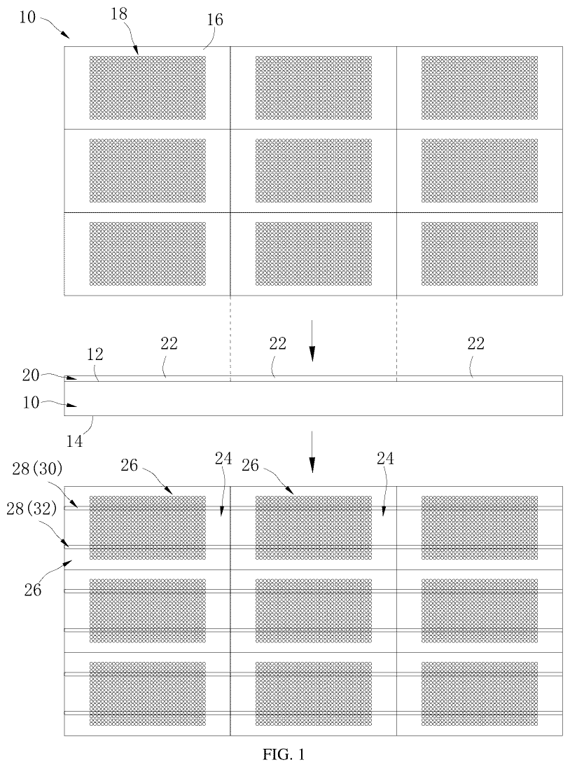

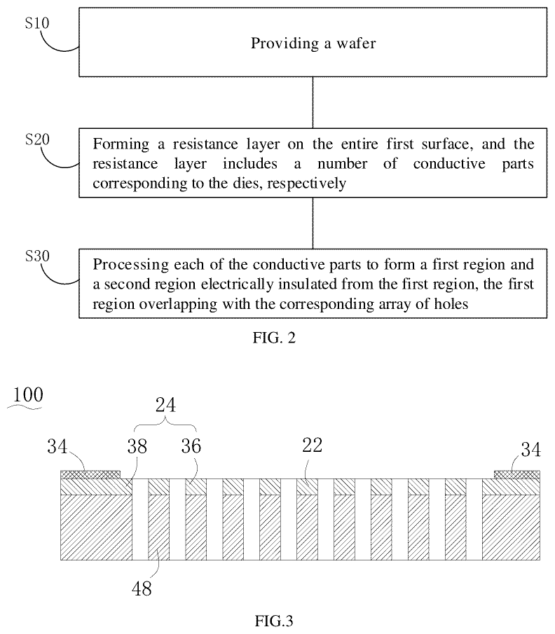

Referring to FIGS. 1-3, the present application discloses a method of manufacturing an atomization core 100, The method includes following steps S10-S30.

In the step S10, a raw substrate 10 is provided. The raw substrate 10 includes a first surface 12 and a second surface 14 opposite to the first surface 12. The raw substrate 10 defines a number of substrate units 16. Each of the substrate units 16 defines an array of holes 18 running through the first surface 12 and the second surface 14;

In the step S20, a resistive layer 20 is formed on the entire first surface 12, and the resistive layer 20 includes a number of conductive parts 22 corresponding to the substrate units 16, respectively.

In the step S30, each of the conductive parts 22 is processed to form a first region 24 and a second region 26 electrically insulated from the first region 24. The first region 24 overlaps with the corresponding array of holes 18.

That is, in the method, the resistive layer 20 is firstly formed by, e.g. vapor deposition, without a mask and thus covers the entire first surface 12. Then the conductive parts 22 of the resistive layer 20 is processed to form a first region 24 wherein the conductive parts 22 overlaps with the array of holes 18. Thereby, after the substrate units 16 are separated, by, e.g., slicing, into the atomization cores 100, the first region 24 can function as an electrothermal film of the atomization core 100. Therefore, the atomization core 100 is manufactured without using a mask, reducing manufacturing cost of the atomization core 100.

In contrast, in related art, during a process of an atomization core, only portions corresponding to an array of holes of a raw substrate is coated with a patter of an electrothermal film. A mask is required and aligned with the raw substrate to avoid other portions of the raw substrate being coated. Obviously, the mask is required to be aligned with the raw substrate precisely. Otherwise the patter of the electrothermal film can be misaligned with the array of holes, causing defects. Moreover, the mask may need to be renewed timely, also increasing cost. In addition, the mask may scratch the raw substrate, which may also cause defects.

While in the method of manufacturing the atomization core 100 of the present disclosure, the resistive layer 20 is coated on the entire first surface 12 of the raw substrate 10 without using a mask and thus alignment between the mask and the raw substrate is omitted, simplifying the process and improving efficiency.

Furthermore, electrically insulated regions, wherein a first region 24 and a second region 26, are processed on the conductive part 22 of each of the substrate units 16, so that the first region 24 overlaps with the array of holes 18. Thus, when the atomization core 100 is working, the oil flowing though the holes 18 is heated by the first region 24 and atomized, ensuring that the atomization core 100 works properly.

In the step S10, it can be known that the raw substrate 10 can be a flat plate, such as, a square plate, a round plate, and plates of other shapes, depending on requirements. The raw substrate 10 can be made of dense materials, such as, sapphire monocrystal, other monocrystalline or polycrystalline materials, and dense ceramics, and also can be made of high-temperature and thermal-shock resistant glass such as quartz glass, borosilicate glass, or aluminosilicate glass.

The raw substrate 10 can be separated into a number of substrate units 16 in accordance with the size of the atomization core 100. Each of the substrate units 16 may eventually be processed into an atomization core 100. A number of substrate units 16 can be arranged to align as a rectangular array, which makes processing the array of holes 18 on the substrate units 16 more convenient, and facilitates the process of cutting the substrate units 16.

The array of hole 18 can be manufactured by a glass perforation technique such as laser perforation. The array of hole 18 includes a number of holes 18, and the aperture diameter of each hole 18 ranges from about 1 μm to about 100 μm. It can be known that the aperture diameter of holes 18 can be designed specifically according to the viscosity of the oil. For example, the higher the viscosity of the oil is, the larger the aperture diameter of the holes 18 can be designed. The specific size of the holes is not limited herein.

In some embodiment, the aperture diameters of the holes 18 can be equal, or unequal to each other. The holes 18 can be arranged as a rectangular array. For example, the holes 18 may be arranged as 8 rows and 10 columns.

In each of the substrate units 16, porosity of the holes 18 may range from about 20% to about 70%. The porosity refers to the ratio of the total volume of the holes to the total volume of the substrate units 16.

In the step S20, the resistive layer 20 can be formed by, e.g., coating, screen printing, vapor deposition, sputtering, or bonded directly to the first surface 12. For example, the entire raw substrate 10 with the array of holes 18 can be placed into the inner coating of a magnetron sputtering device, in this way, can form a resistive layer 20 by sputtering on the entire first surface 12. The resistive layer 20 may form the conductive parts 22 corresponding with the substrate units 16. The processing speed of the resistive layer 20 in the embodiment may reach about 1000 mm/s, thereby drastically improving the processing efficiency.

The resistive layer 20 can be made of conductive and high-heating-efficiency materials such as metals and alloys. For example, the material of the resistive layer 20 can be platinum, palladium, palladium-copper alloy, gold-silver-platinum alloy, titanium-zirconium alloy, nickel-chromium alloy, gold-silver alloy, palladium-silver alloy, gold-platinum alloy, etc. The thickness of the resistive layer 20 ranges from about 100 nm to about 10 μm.

It should be noted that the resistive layers 20 is continuously distributed, or in some cases, the entire resistive layer 20 is formed on the entire first surface 12. That is to say, the resistive layers 20 continuously covers the entire first surface 12 when sputtering the resistive layer 20. So that there is no need of using a mask to position precisely. In this way, the method will become easier, and the efficiency may be improved.

In the step S30, the first region 24 and the second region 26 can be made by removing part of the materials of the conductive part 22, for example, by laser engraving or machining. The first region 24 and the second region 26 are electrically insulated, so that the second region 26 will not conduct electricity when the first region 24 is applied with voltage, ensuring the utilization of electrical energy. The use of laser engraving realizes contactless-processing with the raw substrate. Comparing to the mask process, the risk of scratching can be avoided. In addition, the precision of laser engraving is super high, with a deviation below 10 μm, compared to a deviation about 100 μm of using masks, thereby the accuracy of positioning the heating film can be greatly improved. In this way, the heating film may keep a suitable distance from the edge of the holes, not covering the edge of the holes, and not being too far from the edge of the holes. This improves the working efficiency of the atomization core, and the risk of dry burning can be avoided.

Moreover, the conductive parts 22 can be separated into a first region 24 and a second region 26, to make the first region 24, which overlaps with the array of holes 18, have a suitable size. In this way, the electrical resistance of the first region 24 will be suitable. Usually, a suitable range of the electrical resistance is from about 0.522 to about 102. A suitable value of electrical resistance may facilitate the heating of the first region 24 when being applied with voltage. By controlling the size of the first region 24, the deviation of electrical resistance of the first region 24 should be controlled within about 0.12.

It should be noted that the first region 24 overlaps with the array of holes 18, meaning that there is some intersection between the first region 24 and the array of holes 18. The area of the first region 24 can be larger than, smaller than, or of the same value with that of the array of holes 18. The boundary of the first region 24 can be inside, or outside the area of the array of holes 18; or, part of the boundary of the first region 24 is inside the area of the array of holes 18 while the other part of the boundary is outside the array of holes 18.

The part of the first region 24 that overlaps with the array of holes 18 can be considered as an effective part of the first region 24. The effective part may contact with the oil after the first region 24 is applied with a voltage. In this way, can heat the oil and turns the oil into aerosol.

The first region 24 and the second region 26 can be in regular or irregular shapes. For example, the first region 24 and the second region 26 can both be rectangular, which makes the first region 24 and the second region 26 easier to be processed. In addition, the second region 26 may help the atomization core 100 to dissipate heat, and the heat-dissipating effect of the atomization core 100 can be improved.

In some embodiment, there are one first region 24 and two second regions 26, and the two second regions 26 may locate on opposite sides of the first region 24, or, we may say that the first region 24 is between the two second regions 26.

Of course, in other embodiments, the number of first regions 24 or second regions 26 may change. For example, the number of first regions 24 and that of the second regions 26 may both be one, as the first region 24 and the second region 26 can be arranged side by side. Alternatively, it can be more than one first region 24 or more than one second region 26, each of the regions is electrically insulated from each other, and the first region 24 is located between second regions 26.

In the case that the number of first regions 24 can be more than one, a voltage can be applied to the one or more first regions 24.

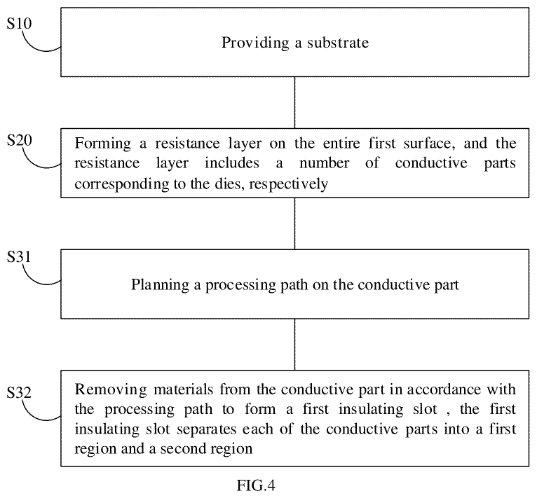

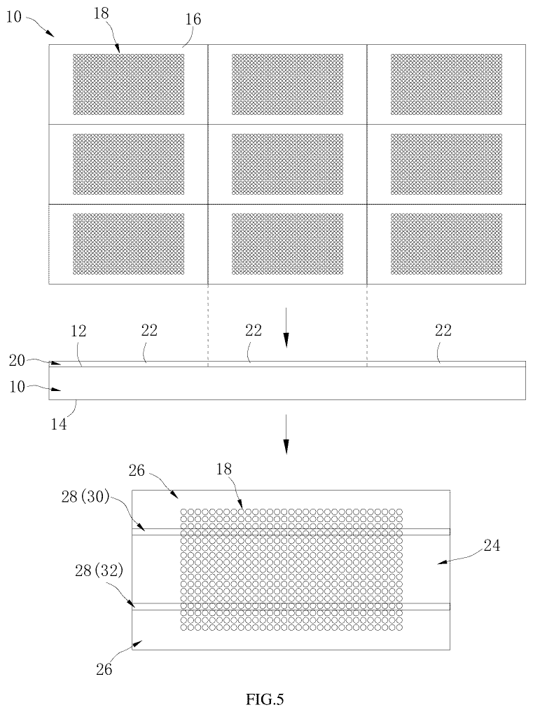

Referring to FIGS. 1 and 4, in some embodiments, the step S30 includes following steps S31-S32.

In the step S31, a processing path on the conductive part 22 can be planed.

In the step S32, materials from the conductive part 22 can be removed in accordance with the processing path to form a first insulating slot 28. The first insulating slot 28 separates each of the conductive parts 22 into a first region 24 and a second region 26, then the first insulating slot 28 passing across each of the arrays of holes 18.

In this way, the use of the first insulating slot 28 can insulate the first region 24 and the second region 26 effectively, and the electrical connection between the first region 24 and the second region 26 will be avoided. Also, the first insulating slot 28 passes across the arrays of holes 18, that is, part of the arrays of holes 18 is located inside the second region 26, so that the oil can be sufficiently supplied without dry burning.

In the step S31, the processing path can be determined by coordinate positioning or by using a vision system.

In the step S32, the first insulating slot 28 can be processed by laser engraving, and in order to make the first region 24 and the second region 26 effectively insulated, the first insulating slot 28 passes across the conductive part 22. The first insulating slot 28 can be a straight slot or a curved slot, and the shape of the first insulating slot 28 can be determined in accordance with the shape of the first region 24 and the second region 26. The shape of the first insulating slot 28 is not limit in the present disclosure.

Referring to FIG. 5, in some embodiments, the step S32 includes: removing the material of the conductive portion 22 in accordance with the processing path to form a first slot 30 and a second slot 32.

The first slot 30 and the second slot 32 are spaced apart and both pass through the arrays of holes 18, the first region 24 is formed between the first slot 30 and the second slot 32, and the first insulating slot 28 includes the first slot 30 and the second slot 32.

In this way, the edge of the array of holes 18 is located inside the second region 26, or rather, part of the array of holes 18 is located outside the first region 24, so that the width of the first region 24 is suitable, ensuring that the resistance of the first region 24 can be effectively heated to provide heat to the oil. In addition, the array of holes 18 is partially located outside the first region 24, making the part of the array of holes 18 inside first region 24 be in contact with the oil during heating process, and damages, such as dry burning, to the first region 24 will be avoided.

The first slot 30 and the second slot 32 may both be formed by laser engraving. Both the first slot 30 and the second slot 32 can be straight or in other shapes. For the example of FIG. 5, in the case that the first slot 30 and the second slot 32 are both straight, they can be set parallel.

For the example of FIG. 6, the first slot 30 and the second slot 32 can be in arc, as the area between them can be similar to the part of an ellipse.

In some embodiments, the first slot 30 and the second slot 32 are symmetrical about the long axis of the array of holes 18, that is, the distance between the first slot 30 and the center of the array of holes 18 is equal to the distance between the second slot 32 and the center of the array of holes 18 in the direction of a same width of the raw substrate 10.

As discussed above, in some embodiments, the first insulating slot 28 includes a first slot 30 and a second slot 32, that is, there can be two first insulating slots 28. Of course, in other embodiments, the number of first insulating slots 28 can be one or more than three, and the specific number of first insulating slots 28 is not limited in the present disclosure.

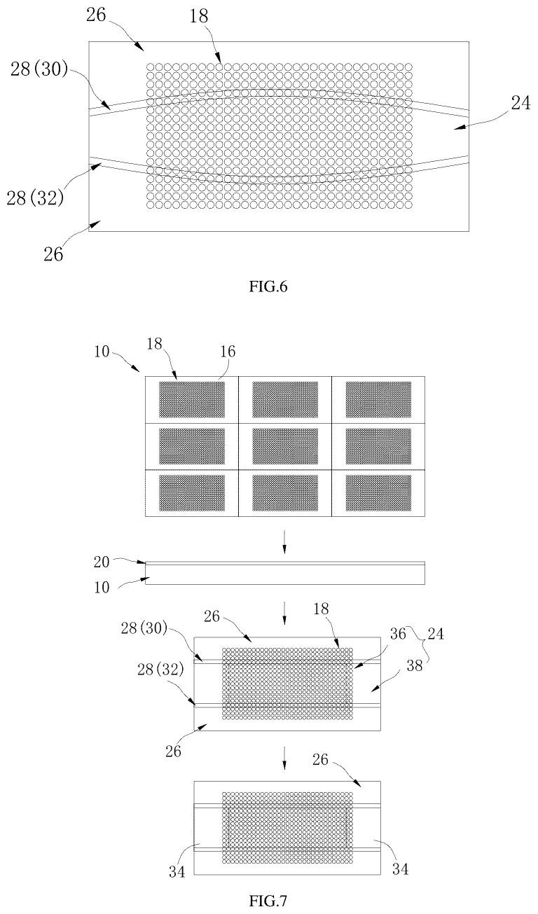

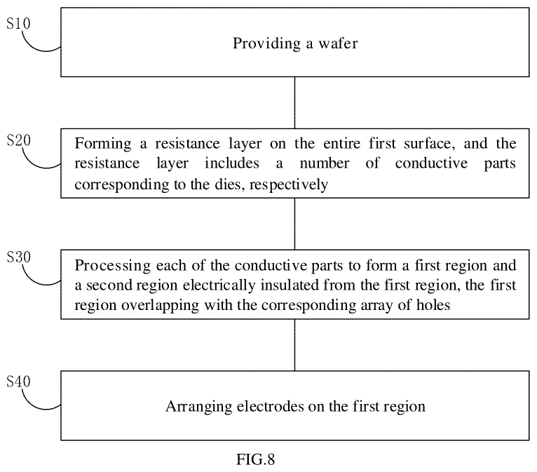

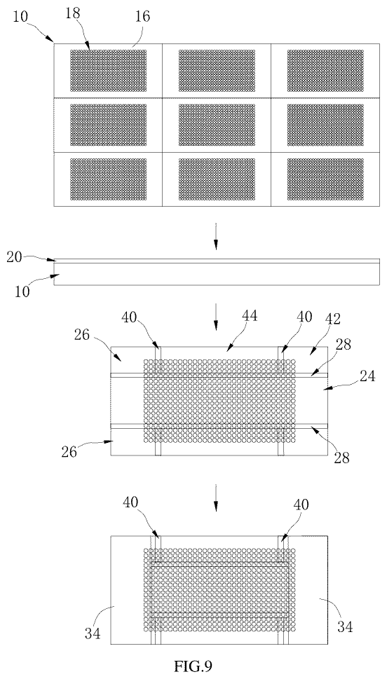

Referring to FIGS. 7-8, in some embodiments, the method further includes a step S40.

In the step S40, electrodes 34 are arranged on the first region 24. In this way, the electrodes 34 facilitate the connection between the first region 24 and an external circuit, so that the external circuit can apply a voltage to the first region 24 through the electrodes 34.

There are two electrodes 34, and the two electrodes 34 are arranged at the two ends of the first region 24. The electrodes 34 can be made of a metal material with low electric resistivity, such as gold or silver, with no limiting in the present disclosure. For example, choosing silver as the material of the electrode 34, can help the processing get better electrical conductivity and lower cost.

The electrode 34 can be set on the first region 24 at least by means of coating or sputtering. It can be known that the electrode 34 is electrically connected to the first region 24.

Referring to FIG. 7, in some embodiments, the first region 24 includes a heating zone 36 and an electrical connection zone 38 connected to the heating zone 36, the electrical connection zone 38 locates outside the array of holes 18, and the heating zone 36 overlaps with the array of holes 18;

The step of arranging the electrodes 34 on the first region 24 includes: arranging the electrodes 34 in the electrical connection zone 38.

In this way, the electrodes 34 may apply a voltage to the heating zone 36 through the electrical connection zone 38, allowing the heating zone 36 to generate heat. Specifically, the end of the heating zone 36 connected to the electrical connection zone 38 extends outside of the array of holes 18. In an embodiment, there can be two electrical connection zones 38, each of the electrical connection zones 38 is arranged with electrodes 34, and the two electrical connection zones 38 are connected to the two ends of the heating zone 36. The area of the heating zone 36 is larger than the area of one of the electrical connection zones 38.

In an embodiment, the shape of the electrical connection zone 38 can be square, making the electrical connection zone 38 have a simple shape that is easy to identify, thus benefiting the arrangement of the electrodes 34 on the electrical connection zones 38 and improving the efficiency of processing the atomization core 100.

Referring to FIG. 13, in some embodiments, the method further includes:

Detecting the resistance of the heating zone 36 between the two electrodes 34;

When the resistance of the heating zone 36 between the two electrodes 34 is less than a preset value, forming a notch 37 on the heating zone 36 to increase the resistance of the heating zone 36.

In this way, the resistance of the heating zone 36 can be formed within a predetermined resistance range during the manufacturing process of the atomizer core 100.

Specifically, the notch 37 can be formed by laser engraving. It can be understood that the notch 37 can destroy the original structure of the heating zone 36, thereby increasing the resistance of the heating zone 36. The number of notches 37 can be one or more, and the length of the notch 37 is 5 μm to 30 μm. The shape of the notch 37 includes but is not limited to a straight line, a broken line, a curved line, etc.

Exemplarily, the resistance of the adjusted heating zone 36 between the two electrodes 34 is 0.5Ω-2Ω.

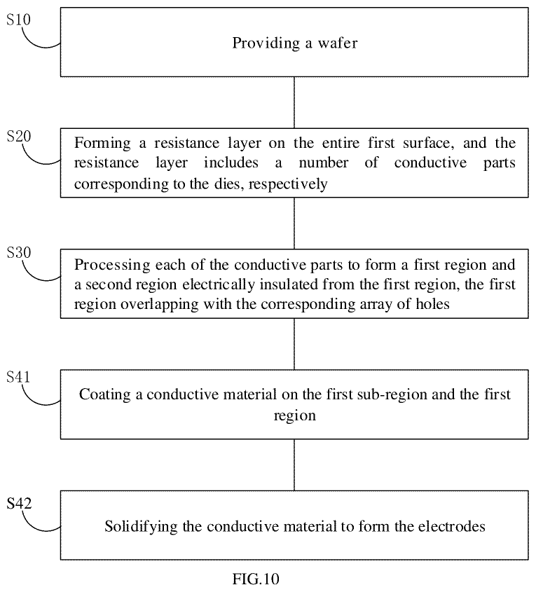

Referring to FIGS. 9-10, in some embodiments, the method of manufacturing further includes:

removing material from the second region 26 to form a second insulating slot 40, the second region 26 can be separated into a first sub-region 42 and a second sub-region 44 by the second insulating slot 40. These two sub-regions are both electrically insulated from each other, the second sub-region 44 is corresponded to an end of the first region 24;

To arrange electrodes 34 on the first region 24 (step S40), in the step S41, a conductive material can be coated on the first sub-region 42 and the first region 24;

In the step S42, the conductive material can be solidified to form the electrodes 34.

In this way, the electrodes 34 are arranged on both the first sub-region 42 and the first region 24 to make it convenient to set the electrodes 34; at the same time, the second insulating slot 40 can effectively isolate the first sub-region 42 and the second sub-region 44. This may prevent the electrodes 34 from being electrically connected to the second sub-region 44, ensuring the heat generation performance of the first region 24.

The first sub-region 42 serves as the edge of the electrically conductive part 22, and the conductive material is coated by the first sub-region 42 through the first region 24. In this way, the boundary of the electrodes 34 does not need to be specially designed, improving the coating efficiency of the conductive materials, and the processing efficiency of the atomization core 100.

Because the electrode 34 is coated on the first region 24 of the first sub-region 42, the width of the electrode 34 is greater than that of the first region 24. Of course, in other embodiments, when the electrode 34 is coated only on the first region 24, the width of the electrode 34 can be of the same as, or smaller than that of the first region 24.

In some embodiments, part of the array of holes 18 are covered by the electrode 34, enabling all the resistances of the first region 24 be corresponded to the array of holes 18 to contact with the oil, preventing the resistances from being damaged by dry burning, and improving the working period of the atomization core 100.

It should be noted that the step of forming the second insulating slot 40 can be operated before or after the step of applying the conductive material. For example, the conductive material can be coated on the first region 24 and the second region 26 first, and after solidifying the conductive material to form the electrodes 34, the second insulating slot 40 can be formed on the second region 26 afterwards. The conductive material is coated on the electrically receiving zone 38 of the first region 24.

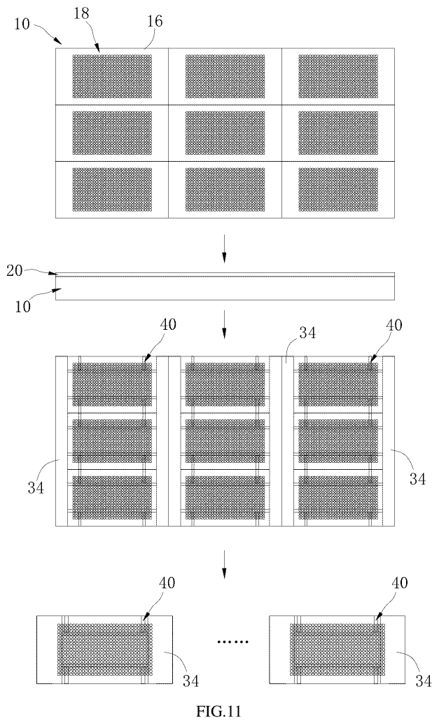

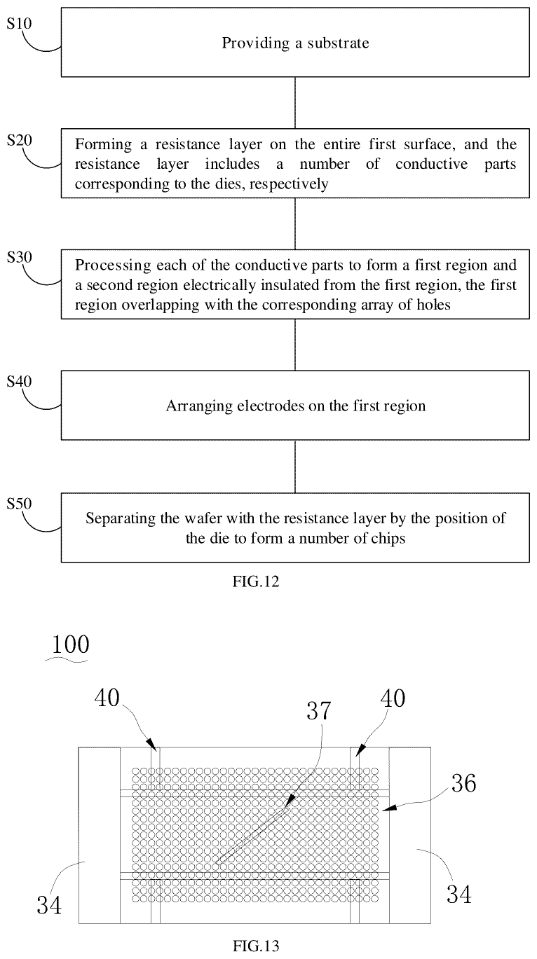

Referring to FIGS. 11-12, in some embodiments, the method of manufacturing further includes:

In the step S50, the raw substrate 10 can be separated with the resistive layer 20 by the position of the substrate unit 16 to form a number of chips 46, each chip 46 includes one substrate unit 16 and one conductive part 22.

In this way, the raw substrate 10 is separated to form the smallest unit of the atomization core 100. Specifically, the raw substrate 10 with a resistive layer 20 can be obtained by the processing method of laser cutting, and each substrate unit 16 serves as the smallest unit of the atomization core 100. After cutting the raw substrate 10, the atomization core 100 or some intermediate product during the period of processing can be obtained.

That is to say, the method of the atomization core 100 in the present disclosure is firstly executed on the entire raw substrate 10. And after all the steps of coating and laser-engraving, the entire raw substrate 10 can be cut into small unit. In this way, the art of using a mask to position precisely would be omitted, and the efficiency can be improved as the method become easier.

It should be noted that step S50 can be executed after finishing step S20 and before step S30, or can be executed after step S30; if step S50 is executed after step S30, step S50 can be executed before or after step S40.

For example, after separating the raw substrate 10 with a resistive layer 20 into a number of chips 46, processing first an insulating slot 28 on each of the chips 46. Later, the first region 24 can be arranged with electrodes 34, and processing to form a second insulating slot 40.

Another example is that the first insulating slot 28 can be processed on the resistive layer 20, then the raw substrate 10 with a resistive layer 20 can be separated into a number of chips 46, after which the electrodes 34 can be arranged on the first region 24, finally processed to form the second insulating slot 40.

Referring again to FIG. 3, providing an atomization core 100, which being made by the method of any of the above embodiments.

Referring again to FIGS. 1-3, in one of the embodiments, the atomization core 100 includes a core substrate 48 and a conductive part 22, the core substrate 48 having an array of holes 18 passing across the core substrate 48 in the direction of the thickness of the core substrate 48; the conductive part 22 is in a plat-shape lying on the core substrate 48, the conductive part 22 includes a first region 24, and a second region 26 electrically insulated from the first region 24, the first region 24 overlaps with the array of holes 18.

In this way, the first region 24 may heat the oil passing through the array of holes 18 and make the oil atomize, and the second region 26 can accelerate the efficiency of heat dissipation of the other parts of the atomization core 100. In this way, the high temperature of the other parts of the atomization core 100 cause negative effects to the components surrounded.

As discussed above, the thickness of the resistive layer 20 ranges from about 100 nm to about 100 μm. Therefore, the thickness of the conductive part 22 also ranges from about 100 nm to about 100 μm.

In some embodiments, the conductive part 22 is formed with a first insulating slot 28, separating the conductive part 22 into a first region 24 and a second region 26, and passing across the array of holes 18.

In this way, the first insulating slot 28 can effectively insulate the first region 24 and the second region 26, which avoids the first region 24 and the second region 26 being electrically connected. In addition, the first insulating slot 28 passes across the array of holes 18, that is, part of the array of holes 18 locate in the second region 26, so that the heat generated by the first region 24 after being applied with voltage can heat the oil completely, and the utilization rate of electrical energy can be high.

Referring to FIG. 7, in some embodiments, the first insulating slot 28 includes a first slot 30 and a second slot 32, the first slot 30 and the second slot 32 are placed apart and both pass across the array of holes 18, with the first region 24 being located between the first slot 30 and the second slot 32.

In this way, a certain part of the edge of the array of holes 18 locate in the second region 26, or rather, part of the array of holes 18 locate outside the first region 24. In this way, the first region 24 has a suitable width, ensuring the effectiveness of heating, that the resistance in the first region 24 can heat the oil.

Referring to FIGS. 3-7, in some embodiments, the first region 24 is arranged with electrodes 34, and the electrodes 34 are electrically connected to the first region 24.

In this way, the electrodes 34 facilitate the connection between the first region 24 and the external circuit, so that the external circuit can apply voltage to the first region 24 by the electrodes 34.

In some embodiments, the first region 24 includes a heating zone 36 and an electrical connection zone 38 connected to the heating zone 36, the electrical connection zone 38 locates outside the array of holes 18, the heating zone 36 overlaps with the array of holes 18, and the electrodes 34 are arranged on the electrical connection zone 38.

In this way, the electrodes 34 can apply voltage to the heating zone 36 through the electrical connection zone 38, allowing the heating zone 36 to generate heat. Specifically, the end of the heating zone 36 connected to the electrical connection zone 38 extends outside the array of holes 18. In some embodiments, there can be two electrical connection zones 38, each of the receiving zones 38 is arranged with electrodes 34, and the two receiving zones 38 are connected at the heated ends of the heating zone 36. The area of the heating zone 36 is larger than that of one of electrical connection zones 38.

Referring to FIGS. 3-9, in some embodiments, the second region 26 is provided with a second insulating slot 40, the second region 26 can be separated by the second insulating slot 40 into an insulated first sub-region 42 and a second sub-region 44. The first sub-region 42 is corresponded to the electrical connection zone 38, and the electrodes 34 extends from the electrical connection zone 38 to the first sub-region 42, and covering at least part of the second sub-region 44.

In this way, the electrode 34 is arranged on both the first sub-region 42 and the first region 24, which facilitates the setting of the electrodes 34 and the improvement of production efficiency of the atomization core 100. At the same time, the second insulating slot 40 may effectively isolate the first sub-region 42 from the second sub-region 44. This may prevent the electrode 34 from being electrically connected to the second sub-region 44, ensuring great heating performance of the first region 24.

In some embodiments, the heating zone 36 is formed with notches 37, and the notches 37 are used to adjust the resistance of the heating zone 36 between the two electrodes 38. In this way, the notches 37 can form the resistance of the heating zone 36 within a predetermined resistance range.

It should be noted that the section without expanded description of the atomization core 100 in some embodiments may refer to the same or similar parts of the methods described above, and will not be repeated here. Alternatively, the explanatory description of the methods of the above-described embodiments can apply to the atomization core 100 mentioned above.

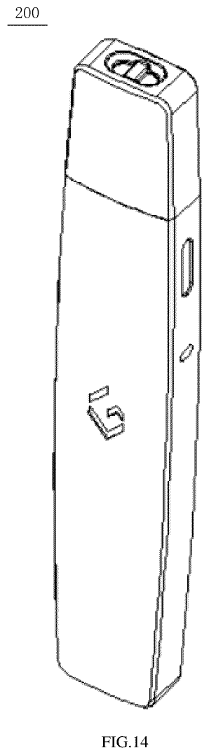

Referring to FIG. 14, the atomization device 200 in some embodiments includes the atomization core 100 of any of the above-mentioned embodiments. The atomization device 200 in some embodiments is a device that can produce aerosol from oil when provided heat. It needs to be noted that the oil in the some embodiments can be a liquid that can produce aerosol.

In the description of the embodiments of the present disclosure, terms such as “first” and “second” are used herein for purposes of description and are not intended to indicate or imply relative importance or significance or imply number of technical features indicated. Therefore, a “first” or “second” feature may explicitly or implicitly include one or more features. Furthermore, in the description, unless indicated otherwise, “a number of” refers to two or more.

Reference throughout this specification to “an embodiment”, “some embodiments”, “illustrative embodiment”, “an example”, “a specific example”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific example”, or “some examples” in various places throughout this specification are not necessarily referring to the same embodiment or example of the disclosure. Furthermore, the specific features, structures, materials, or characteristics can be combined in any suitable manner in one or more embodiments or examples.

Although explanatory embodiments have been shown and described, it would be appreciated by those skilled in the art that changes, alternatives, and modifications can be made in the embodiments without departing from spirit and principles of the disclosure. Such changes, alternatives, and modifications all fall into the scope of the claims and their equivalents.

1. A method of manufacturing an atomization core, comprising:
providing a raw substrate, the raw substrate comprising a first surface and a second surface opposite to the first surface, and a plurality of substrate units, each of the substrate units defining an array of holes running through the first surface and the second surface;
forming a resistance layer on the entire first surface, and the resistance layer comprising a plurality of conductive parts corresponding to the substrate units, respectively;
processing each of the conductive parts to form a first region and a second region electrically insulated from the first region, the first region overlapping with the corresponding array of holes.

2. The method of claim 1, wherein the step of processing the conductive parts of the substrate units to form a first region and a second region insulated from the first region, comprises:
planning a processing path on the conductive parts;
removing materials from the conductive parts in accordance with the processing path to form a first insulating slot,
the first insulating slot separating each of the conductive parts into a first region and a second region. The first insulating slot passes across each of the arrays of holes.

3. The method of claim 2, wherein the step of removing the materials of the conductive parts to form the first insulating slot according to the processing path, comprises:
removing the materials from the conductive parts in accordance with the processing path to form a first slot and a second slot,
the first slot and the second slot being apart from each other while both passing across each of the arrays of holes, the first region being formed between the first slot and the second slot, and the first insulating slot comprising the first slot and the second slot.

4. The method of claim 1 further comprising:
arranging electrodes on the first region.

5. The method of claim 4, wherein the first region comprises a heating zone, and an electrical connection zone connected to the heating zone, the electrical connection zone locates outside the corresponding array of holes, and the heating zone overlaps with the array of holes;
wherein the step of arranging electrodes on the first region, comprises:
arranging the electrodes on the electrical connection zone.

6. The method of claim 5 further comprising:
detect the resistance of the heating zone between the two electrodes;
when the resistance is less than a preset value, forming a notch on the heating zone to increase the resistance of the heating zone.

7. The method of claim 4 further comprising:
removing materials from the second region to form a second insulating slot, the second insulating slot separating the second region into two insulating sub-regions as a first sub-region and a second sub-region, the second sub-region corresponding to a top end of the first region;
wherein the step of arranging the electrodes on the first region, comprises:
coating a conductive material on the first sub-region and the first region
solidifying the conductive material to form the electrodes.

8. The method of claim 1 further comprising:
separating the raw substrate with the resistance layer by the position of the substrate units to form a plurality of chips, each of the chips comprising one substrate unit and one conductive part.

9. The method of claim 1, wherein the step of forming a resistance layer on the entire first surface, comprises:
forming a resistance layer on the entire first surface.

10. An atomization core, comprising:
a core substrate, the core substrate defining an array of holes therethrough in a thickness direction thereof;
a conductive part, the conductive part being in slice and lying on the core substrate, the conductive part comprising a first region and a second region insulated from the first region, the first region overlapping with the array of holes.

11. The atomization core of claim 10, wherein the conductive part defines a first insulating slot, and the first insulating slot separates the conductive part into a first region and a second region, while passing through the array of holes.

12. The atomization core of claim 11, wherein the first insulating slot defines a first slot and a second slot, the first slot and the second slot are spaced apart from each other while both pass through the array of holes, and the first region locates between the first slot and the second slot.

13. The atomization core of claim 10, comprising electrodes formed on the first region, and the electrodes being electrically connected to the first region.

14. The atomization core of claim 13, wherein the first region comprises a heating zone and an electrical connection zone connected to the heating zone, the electrical connection zone locates outside the array of holes, the heating zone overlapping with the array of holes, the electrodes being arranged on the electrical connection zone.

15. The atomization core of claim 14, wherein the second region defines a second insulating slot, the second insulating slot separates the second region into a first sub-region and a second sub-region electrically insulated from the first sub-region, the first sub-region corresponds to the electrical connection region, and the electrodes extend from the electrical connection region to the first sub-region, covering at least part of the first sub-region.

16. The atomization core of claim 15, wherein the heating zone is formed with a notch, and the notch is used to adjust the resistance of the heating zone between the two electrodes.

17. An atomization core being made by the method described in claim 1.

18. An atomization device comprising the atomization core of claim 10.
